(19) United States
(12) Patent Application Publication
(10) Pub. No.: US 2009/0283096 A1
(43) Pub. Date: Nov. 19, 2009

(54) PROTECTIVE MASK AGAINST BIOLOGICAL AGENTS MADE OF TWO PARTS

(75) Inventor: Stefano Cerbini, Pesaro (IT)

Correspondence Address: YOUNG & THOMPSON, 209 Madison Street, Suite 500, ALEXANDRIA, VA, 22314, US

(73) Assignee: CL.COM S.R.L., Forli (IT)

(21) Appl. No.: 12/306,668

(22) PCT Filed: Apr. 27, 2007
(86) PCT No.: PCT/IT2007/000309

§ 371 Date: Dec. 24, 2008

(30) Foreign Application Priority Data
May 18, 2006 (IT) PS2006A000012

(51) Int. Cl. A62B 18/10; A62B 18/02; A62B 7/10; B32B 37/12

(52) U.S. Cl. 128/206.15; 128/206.28; 128/206.19; 156/73.1

(57) ABSTRACT

The invention refers to a personal protective equipment for the respiration that is made up of an upper (1) and a lower (2) part characterized in that the two parts are both flat and exactly identical, are circle-shaped with a straight edge and a curved one, arc-shaped, and are linked together through the curved edge (3). The equipment can be re-positioned in a folded position for storage, while during the use, it creates an air-chamber, crescent shaped, over the nose and the mouth of the user, and the linear edges of the two parts are in contact with the face. The protective equipment of the invention, thanks to its small size, high comfort and high sealing along its perimeter, is particular effective in the applications where a high tightness is required for high protection level such as the use to protect against biological agents.

### FIELD OF THE INVENTION

The present invention refers to a personal protective equipment with features, in terms of design, comfort and efficiency, particularly suit to critical applications such as the protection against biological agents

### BACKGROUND ART

The protective masks are commonly used in a wide range of sectors to protect the respiratory tract against particles suspended in the air, dusts and against solid and liquid aerosols.

The masks are usually shared into two categories: the cup-masks and the flat-folding ones.

The description of the first ones, for example, can be found in GB-A-1 569 812, GB-A-2 280 620, U.S. Pat. No. 4,536,440, U.S. Pat. No. 4,807,619, U.S. Pat. No. 4,850,347, U.S. Pat. No. 5,307,796, U.S. Pat. No. 5,374,458.

The folding ones, that can be kept folded until their use, are described in the following patents: WO 96/28217, U.S. Ser. No. 08/612,527 patent application, U.S. Pat. No. 5,322,061, U.S. Pat. No. 5,020,533, U.S. Pat. No. 4,920,960 and U.S. Pat. No. 4,600,002, CA 2368844, U.S. Pat. No. 5,735,270.

One of the most common kind of mask is made up of two parts, linked together, as the ones described in U.S. Pat. No. 5,701,893, U.S. Pat. No. 5,701,892, U.S. Pat. No. 4,419,993 and U.S. Pat. No. 5,322,061.

These masks are sometimes stiff, folded, plied or reinforced in order to ensure enough room between the mask and the face, that is to say, to let the mask, once opened, to be shaped and moulded in order to create enough room in the mouth-nose area to allow an easy breathing; all these characteristics make the masks hard to manufacture.

In other cases, the masks do not offer enough tightness on the face.

Consequently, there is a request for a mask that, besides guaranteeing a perfect tightness and protection, is simply designed and easy to manufacture.

### DESCRIPTION OF THE INVENTION

The present invention refers to a personal protective equipment for the respiration that is made up of an upper and a lower part characterized in that the two parts are both flat and exactly identical, are circle-shaped with a straight edge and a curved one, arc-shaped, and are linked together through the curved edge.

The equipment can be re-positioned in a folded position for storage, while during the use, it creates an air-chamber, crescent shaped, over the nose and the mouth of the user, and the linear edges of the two parts are in contact with the face; in particular, once the mask has been worn, the linear edge of the upper part gets in touch with the nose and the high part of the face of the user, while the linear edge of the lower part is in touch both with the chin and the lower part of the user face.

Both parts are made of one single layer or a multi-layer structure, where at least one layer is a filtering media.

Typically, the parts are made up of at least three layers, an internal layer having supporting function, to provide and keep the shape, an external layer that covers and protects the filtering media and a central one acting as a filter.

The Personal Protective Equipment (PPE) is also complete with elastic strips, to keep the PPE positioned on the user's face; these bands are put on the meeting point of the straight edge and the curved one of the two parts. The elastic bands are installed using conventional methodologies as a sealing or a mechanic insertion or, preferably, by means of an elastic band holder that facilitates the elastic bands tighten, to be adjusted according to the dimension of the face.

Moreover, the PPE can also include further devices commonly used for face masks as gaskets, nose rings, soft stuff, adhesive tapes and exhaling valves.

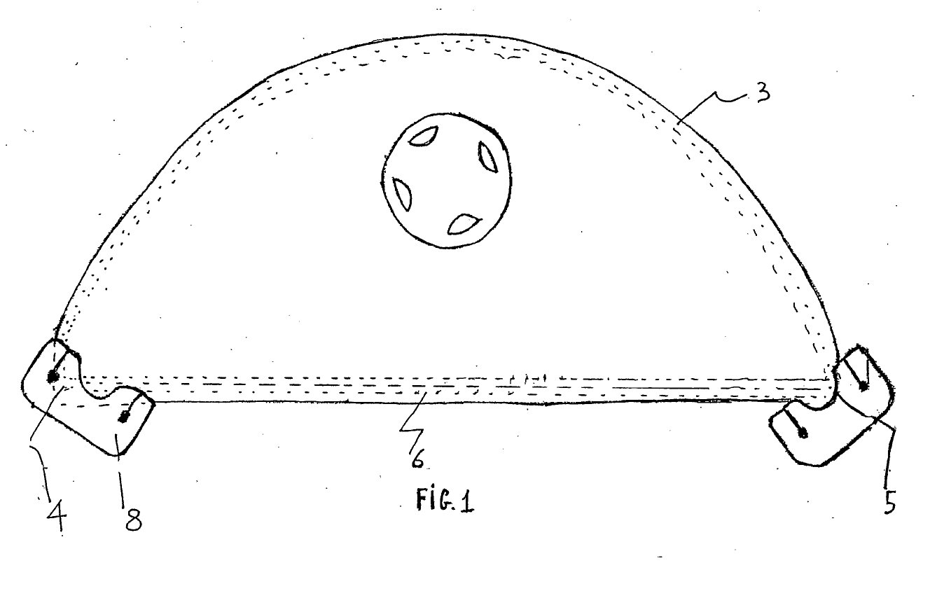

The PPEs of the present invention are illustrated in FIGS. 1-3, in the version with elastic band holders and exhaling valve.

In FIG. 1 the PPE is frontal and fold-flat.

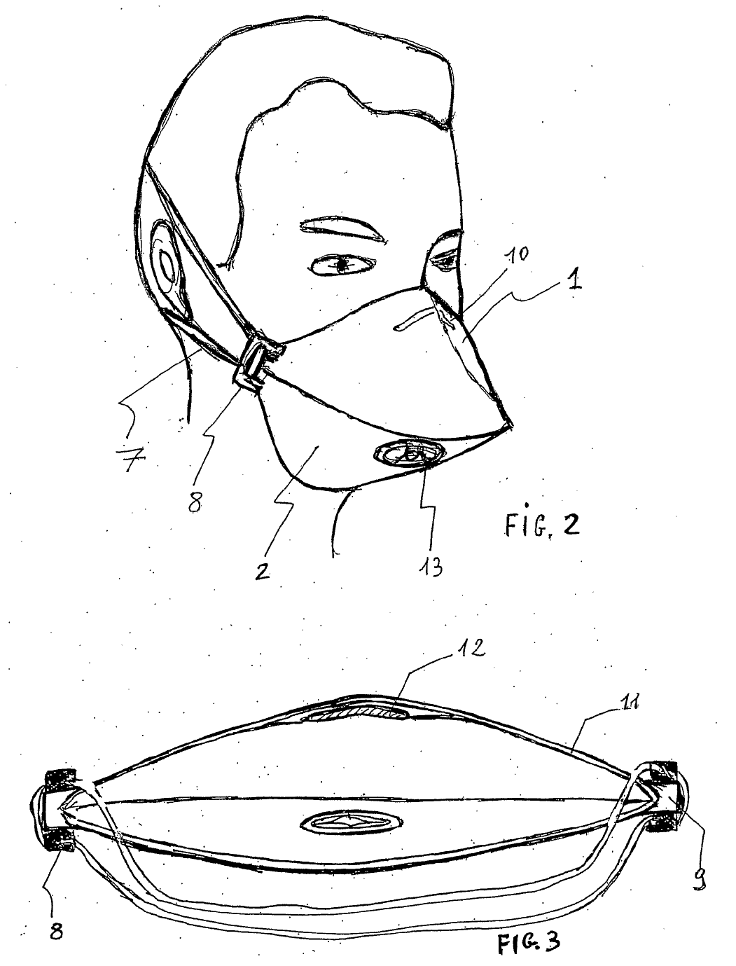

In FIG. 2 the PPE is frontal and wide-opened on the face of the user.

In FIG. 3 the PPE is in a back perspective and partially opened.

In FIG. 1, the PPE is folded for storage before the use and can be wrapped in a film so that it can be put in a pocket of the user; it is circle-shaped because of the two parts perfectly overlapping.

In FIG. 2, the PPE is worn by the user, the upper part (1) and the lower one (2) are opened and this creates room in the mouth-nose area and the straight edges of the two parts are in contact with the face of the user.

The seam of the two parts is located along the curved edge (3) and goes from point (4) to point (5); the seam can be sewed, welded, mechanic or adhesive and in particular the ultrasonic seam is to be preferred. If the PPE is multi-layered and one of these layer is the filtering media, the straight external edges (6) of the single parts are also welded or sewed together in order to join the different layers.

The elastic bands (7) act to keep the PPE on the face of the user and to guarantee its tightness; anyway, different shapes and dimensions of the different faces (as well as the children and teens shape of the face that is not well defined) do not allow a definition of universal parameters concerning the strength of the material the elastic bands are made of; consequently, the efficacy of the protective device is usually linked to the ability of the wearer to mould the mask to one's own face.

The fixing devices (8), acting as elastic band holders, are on the contrary particularly useful to adjust the tight of the elastic bands in order to guarantee a perfect tightness.

The elastic band holders can be different in shape and in dimension and can be made of different materials, preferably in plastic stuff and the polypropylene is to be preferred.

For example, the elastic bands holders can be rectangular with the sides length from 40 to 10 mm.

The elastic band holders are fixed to the body of the mask through mechanic, adhesive, heat or ultrasonic seams, sewing or further seams commonly used.

In order to fix the elastic band holders easy, some attachment points (9) can be planned, either as an eyelet or a tongue, extending from the sides (4) and (5) common to the two parts.

The tongues are in the same material as parts (1) and (2) and they are minimally sized to allow the elastic band holder fixing; they are typically ranged between 10 e 30 mm in length, and the range between 15 and 20 mm is to be preferred.

The elastic bands (7) can be in polyurethane, polyisoprene, copolymers butylene/styrene, elastic rubber, elastomeric materials; typically the elastic bands are made of a combination of an elastic material, for example. synthetic rubber and a thermoplastic component as for example. polypropylene, chosen for its compatibility with the material of the mask. The PPE can also include further accessories widely known.

For example, in the upper part (1) a nose clip (10) can be placed, in order to cover the nose bridge and to help an accurate application of the mask on the nose and on the cheek area. This nose clip can be made up of a folding ring in metal and it can be placed on the external side of the upper part (1) or on the internal one or, if the PPE is multi-layered, it can be placed among the layers. The position of the nose clip on the internal side of the upper part (1) is to be preferred, and it can be connected to the PPE through conventional devices as for example an adhesive plaster. Moreover, a stuffing, as for example a stripe in elastomeric material or foam, can be placed on the inside surface of the upper part, behind the nose clip, with the aim of improving the comfort and the adherence. Gaskets (11) can also be used to reduce air leakages between the PPE and the face, like the ones described in U.S. Pat. No. 4,827,924 or in U.S. Pat. No. 4,688,566 or in WO2005/077214A1; they are made of elastomeric soft stuff, as for example ethylene vinyl acetate, or made of resins based on natural rubber latex or on silicone or other suitable material and they are located along the upper and lower edges of the mask, starting from the side joints. This coating is to seal the mask to any shape of faces; it offers a perfect and safe sealing, by preventing any creation of micro-holes and any deformations that would allow the contaminants passing through the mask without being removed from the filtering stuff.

It is also possible to place an adhesive band (12) behind the nose clip This band can be shaped and have the typical structure of normal plasters; for example, it is made of a stripe in plastic, having at least one adhesive side, where one surface is used to let the band seal to the upper part inner side of the PPE, for example on the gasket (11) behind the nose clip, through a pressure, if the band is bi-adhesive, or through stitching in case of mono-adhesive band, while the other surface, that is adhesive, is covered by a protective film.

When the user needs to use the PPE, the protective film shall be removed and the band pressed against the skin allowing the adherence to the nose area and under the eyes.

As a result, the sealing is enhanced in the nose areas, where the folds and deformations are usually noticeable.

The adhesive band and the nose clip lengths are almost the same and they can be ranged between 80 and 100 mm.

Finally, the PPE can also be equipped with one or more exhaling valves (13) to help the respiratory act, that open when breathing out, due to the increased inside pressure, while they close when breathing in, making the air passing through the filtering membrane; the valve is typically with a membrane, as per the ones described for example in U.S. Pat. No. 4,827,924, U.S. Pat. No. 347,298, U.S. Pat. No. 347,299, U.S. Pat. No. 5,509,436, U.S. Pat. No. 5,325,892 or such as in WO 2005/077214A1 ideal to protect against biological agents.

The valve can be fixed to whatever of the two parts, but the lower one (2) be preferred, typically centrally and near the curved edge of the lower part.

The valve is lodged through a welding, the ultrasonic one is to be preferred, or through adhesive jointing, mechanic closing or other known technologies.

The PPE of the present invention seals to the face and suits the user's face and in particular the outline perfectly, on the cheeks and the nose; thanks to these features, it can be used in the working activities that require a top protection against any agent that is able to penetrate the PPE, to guarantee a high level of protection as the for example against biological agents, dusts, solid and liquid aerosols.

The PPE of the present invention can be manufactured in different sizes, in order to suit the different user's faces.

The two parts' width, that is to say the distance between points (4) and (5) which is the same as the linear edge length, is preferably comprised between 170 and 260 mm, and to be preferred between 190 and 230 mm. The height of the two parts, which goes from the middle of the linear edge to the middle of the curved edge, is preferably comprised between 70 and 140 mm, and in particular, between 85 and 115 mm is to be preferred.

The radium of the circular section is preferably comprised between 85 and 155 mm, and between 90 and 130 mm is to be preferred.

Typically the PPE can be manufactured in a medium/large size, between 210 and 220 mm in width, between 95 and 105 mm in height, the radium between 105 and 115 mm, or in a small/medium size, between 200 and 210 mm in width, between 85 and 95 mm in height and the radium between 95 and 105 mm.

The shape, the geometry and the dimensions of the PPE of the present invention create, once worn, an air-chamber to allow a comfortable fit and avoid the mask to fold on the face, without the devices present in other PPEs that make them complex and cumbersome.

The surface is at the very least to guarantee the air passage to breath normally, and in the meantime, to allow the use of highly filtering devices that are highly resistant against air penetration through the mask. At the same time, the shape, the geometry and the dimensions guarantee a perfect tight of the perimeter on the face of the user in the nose area, cheeks and chin, while allowing free movements of the jaw without loosing the adherence.

Moreover, the dimensions of the PPE of the present invention are reduced compared to the ones known for the same use and this, together with a perfect flatness of the mask when folded, makes the PPE particularly comfortable when worn and also to be stored, thanks to its size.

The PPE of the present invention can be manufactured as follows:
cutting rectangular pieces of the fabric through a cutting shaped hollow punch (also creating the hole for the valve, if required)
fixing the accessories, if any, as gaskets, valves, clips, adhesive band
overlapping two rectangles of fabric to create the two parts of the PPE
joining the materials along the curved profile of an arc (and junction of the valve, if any)
cutting using a circular shaped hollow punch (and creation of the two strips where to put the elastic band-holders)
fixing the elastic bands (subject to fix the elastic band holders)

Joins and fixing points can be made through known technologies, as for example gluing, pressure or welding.

The junctions of the material, of the valve and of the elastic band holders should be preferably welded and the ultrasonic welding is to be preferred. Fixing of gaskets, clips and adhesive band should be preferably through adhesive.

For example, a PPE of the present invention, which was multi-layered, complete with an exhaling valve, gaskets, adhesive band, strips for the elastic band holders, elastic band holders and elastic bands has been made as follows:
the layers of fabric were overlapped in order to create the upper part and, in the same way, the layers of fabric to create the lower part were overlapped as well
using a shaped hollow punch cutter, some rectangles were cut for the upper part and some for the lower part with a hole for the valve
the different layers of the upper part were ultrasonic welded in the area of the straight profile of the PPE and in the area of the edges in order to place the elastic band holders
the same thing for the lower part and the valve was placed using the ultrasonic welding where the hole was located
some EVA stripes were jointed through an adhesive to create the gaskets for the lower part
some EVA stripes were jointed through an adhesive, a nose clip put in between, in order to create the gaskets for the upper part
using a hollow punch cutter the stripes were shaped and then attached with the adhesive to the correspondent parts
a bi-adhesive tape, with a peel-off protective film, was put on the upper part, behind the nose clip
the upper and lower parts were jointed through ultrasonic welding along the curved profile of the round part
through a shaped cutter the PPE was cut along the perimeter that includes the two edges to place the elastic band holders
the two elastic band holders were fixed on the two edges through an ultrasonic welding
therefore the elastic bands were put into the elastic band holders

This working procedure is quite simple and it can be adjusted to low-cost automatic processing.

In-line automatic processing can also include a few steps in only one; for example, a round roll can be simultaneously used both for welding and cutting the materials.

The simplicity of the processing, together with the small dimensions, allow a reduced consumption of raw materials and a reduced environmental impact as the material to be discarded is few.

The materials used to produce the two parts are typical air permeable materials; for example if the structure is multi-layered, the inner layer can be made of non-woven fabric, as in polyester or polypropylene, and typically in polyester, while the outer layer is usually made of non-woven fabric in polyolefin, in polyester or nylon, typically in meltblown polypropylene fibres, while the filtering media can be chosen according to the kind of protection requested.

In particular, it could be in non-woven fabric as melt-blown microfibers, as the ones described in U.S. Pat. No. 5,706,804, U.S. Pat. No. 5,472,481 or U.S. Pat. No. 5,411,576, typically in polypropylene.

The PPE of the present invention, thanks to its small size, high comfort and high sealing along its perimeter, is most used to protect against biological agents and in particular against common bacteria and viruses and against highly dangerous micro-organisms as anthrax, tuberculosis, HBV and HCV.

For these uses, the filtering media can preferably be the one described in WO 2005/077214 A1 composed of borosilicate micro-glass fibers bound together by a resin and supported by a cellulose based substrate. As an example, here below we would remind the results concerning the protective performances against bacteria and viruses of a PPE of the present invention; the PPE is multi-layer structured characterized in an inner layer in non-woven fabric in polypropylene fibers, in an outer layer in meltblown polypropylene fibers and in a filtering layer composed of borosilicate micro-glass fibers bound together by a vinyl acetate resin, the fiber matrix being supported by a cellulose based substrate and the structure being treated with a silicone based coating to impart hydrophobic properties.

The PPE used in the testing activity has elastic band holders, nose clip, gaskets along the perimeter of the PPE, adhesive band behind the nose; in addition it is equipped with the exhaling valve described in WO 2005/077214 A1.

The tightening of the mask has been checked through tests carried out using mask-proof devices and obtaining excellent results.

The tests were carried out using testing micro-organisms while simulating a real breathing through a Sheffield head and self-respirator. The mask was placed on a Sheffield head in order to simulate its use and the head was placed inside a test chamber. A known quantity of the test micro-organism was fed into an aerosol generator and nebulised inside the test chamber.

Therefore the breathing machinery was turned on in order to simulate human breathing and the inhaled air was collected into a bubbler containing a salt solution.

After a certain time, the microbial count of the solution was performed. The number (Nv) of the micro-organisms able to cross the PPE was compared with the number of the micro-organisms (Na) dispersed in the air inside the test chamber, determined through a white test.

The result is shown as a retention rate (%) of the micro-organism used for the test, through the formula here below:

Retention rate (%)=(Na−Nv)/Na×100

The tests were run for 30 minutes at room temperature using different micro-organisms and different mask's sizes; the Brevundimonas diminuta ATCC 19146 has been used as test micro-organism for bacterial agents, while the MS-2, National collection of Industrial bacteria (NCIMB), number 10108, lot 22122004, has been used as test micro-organism for viral agents.

The results are the following:

| | Test micro- | White test | Sample test | Reten- |
|---|---|---|---|---|
| PPE | organism | (Na) cfu/ml | (Nv) cfu/ml | tion rate |
| Small-Medium | Bacterial agents | 170.000 | 1.300 | 99.24% |
| Small-Medium | Viral agents | 13.500.000 | 120.000 | 99.11% |
| Medium-Large | Bacterial agents | 168.000 | 1.300 | 99.23% |
| Medium-Large | Viral agents | 11.100.000 | 101.000 | 99.09% |

In conclusion the PPE of the present invention combines the features of simple design and easy manufacturing process with a comfortable use, thanks to the perfect flatness and reduced sizes, and with an high efficiency in terms of tightness and breathability.

These features in terms of comfort and efficiency make the PPE particularly suit to critical applications such as the protection against biological agents as viruses, bacteria, fingi and parasites of groups 1-2-3-4 listed in the 54/2000 Directive.

Although particular embodiments of the present invention have been described in the foregoing description, it will be understood by those skilled in the art that any simple modification and rearrangement will not depart from the spirit or essential attributes of the invention which are defined in the following claims.

1-31. (canceled)

32. Personal protective equipment for the respiration made up of an upper and a lower part wherein the two parts are both flat, exactly identical, circle-shaped with a straight edge and a curved one, and are linked together through the curved edge, characterized in that the linear edge length of the two parts is comprised between 170 and 260 mm, the distance between the middle of the linear edge and the middle of the curved edge of the two parts is comprised between 70 and 140 mm, and the radium of the circular section is comprised between 85 and 155 mm. The equipment can be re-positioned in a folded position for storage with the two parts perfectly overlapping, while during the use, it creates an air-chamber, crescent shaped, over the nose and the mouth of the user, and the linear edges of the two parts are in contact with the face; in particular, once the mask has been worn, the linear edge of the upper part gets in touch with the nose and the high part of the face of the user, while the linear edge of the lower part is in touch both with the chin and the lower part of the user face.

33. Personal protective equipment as claimed in claim 32 characterized in that the linear edge length of the two parts is comprised between 190 and 230 mm, the distance between the middle of the linear edge and the middle of the curved edge of the two parts is comprised between 85 and 115 mm and the radium of the circular section is comprised between 90 and 130 mm.

34. Personal protective equipment as claimed in claim 32 characterized in that the linear edge length of the two parts is comprised between 210 and 220 mm, the distance between the middle of the linear edge and the middle of the curved edge of the two parts is comprised between 95 and 105 mm and the radium of the circular section is comprised between 105 and 115 mm.

35. Personal protective equipment as claimed in claim 32 characterized in that the linear edge length of the two parts is comprised between 200 and 210 mm, the distance between the middle of the linear edge and the middle of the curved edge of the two parts is comprised between 85 and 95 mm and the radium of the circular section is comprised between 95 and 105 mm.

36. Personal protective equipment as claimed in claim 32 characterized in that the two parts are made of one single layer.

37. Personal protective equipment as claimed in claim 32 characterized in that the two parts are made of a multi-layer structure.

38. Personal protective equipment as claimed in claim 32 characterized in that the two parts are made up of at least three layers, an internal layer having supporting function, to provide and keep the shape, an external layer that covers and protects the filtering media and a central one acting as a filter.

39. Personal protective equipment as claimed in claim 32 characterized in that the two parts contain a filtering media.

40. Personal protective equipment as claimed in claim 32 characterized in that the two parts contain a filtering layer composed of borosilicate micro-glass fibers bound together by a vinyl acetate resin, the fiber matrix being supported by a cellulose based substrate and the structure being treated with a silicone based coating to impart hydrophobic properties.

41. Personal protective equipment as claimed in claim 32 characterized in that the seam of the two parts can be sewed, welded, mechanic or adhesive.

42. Personal protective equipment as claimed in claim 37 characterized in that the straight external edges of the single parts are seamed by sewing, welding, mechanical or adhesive means.

43. Personal protective equipment as claimed in claim 41 characterized in that the seams are made by ultrasonic welding.

44. Personal protective equipment as claimed in claim 32 complete with elastic strips to keep the PPE positioned on the user's face, put the meeting pint of the straight edge and the curved one of the two parts.

45. Personal protective equipment as claimed in claim 44 characterized in that the elastic bands are installed by means of an elastic band holder, fixed on the extreme sides common to the two parts, that facilitates the elastic bands tighten, to be adjusted according to the dimension of the face.

46. Personal protective equipment as claimed in claim 45 characterized in that the elastic band holders can be made in plastic stuff, preferably in polypropylene.

47. Personal protective equipment as claimed in claim 45 characterized in that, in order to fix the elastic band holders easy, some attachment points are planned, either as an eyelet or a tongue, extending from the extreme sides common to the two parts.

48. Personal protective equipment as claimed in claim 32 characterized in that it is equipped with a nose clip and an eventual stuffing placed on the inside surface of the upper part, behind the nose clip.

49. Personal protective equipment as clamed in claim 48 characterized in that an adhesive band is place on the inner surface of the upper part, behind the nose clip.

50. Personal protective equipment as claimed in claim 32 characterized in that it is equipped with at least one exhaling valve.

51. Personal protective equipment as claimed in claim 40 characterized in that the exhaling valve is fixed to the lower part.

52. Personal protective equipment as claimed in claim 32, characterized in that gaskets to reduce air leakages are located along the upper and the lower edges of the mask.

53. Process for manufacturing personal protective equipment for the respiration characterized in the following steps:
cutting rectangular pieces of the fabric through a cutting shaped hollow punch (also creating the hole for the value, if required)
fixing the accessories, if any, as gaskets, valves, clips, adhesive band
overlapping two rectangles of fabric to create the two parts of the PPE
joining the materials along the curved profile of an arc (and junction of the valve, if any)
cutting using a circular shaped hollow punch (and creation of the two strips where to put the elastic band-holders)
fixing the elastic bands (subject to fix the elastic band holders)

54. Process as claimed in claim 53 characterized in that the junctions of the material, of the valve and of the elastic band holders are welded, preferably ultrasonic welded while the fixing of gaskets, clips and adhesive band is preferably through adhesive.

55. Process for manufacturing personal protective equipment for the respiration with multi-layer structure, complete with an exhaling valve, gaskets, adhesive band, strips for the elastic band holders, elastic band holders and elastic bands, characterized in the following steps:
the layers of fabric are overlapped in order to create the upper part and, in the same way, the layers of fabric to create the lower part are overlapped as well,
using a shaped hollow punch cutter, some rectangles are cut for the upper part and some for the lower part with a hole for the valve,
the different layers of the upper part are ultrasonic welded in the area of the straight profile of the protective equipment and in the area of the edges in order to place the elastic band holders,
the same thing for the lower part and the valve is placed using the ultrasonic welding where the hole is located,
some EVA stripes are jointed through an adhesive to create the gaskets for the lower part,
some EVA stripes are jointed through an adhesive, a nose clip put in between, in order to create the gaskets for the upper part,
using a hollow punch cutter the stripes are shaped and then attached with the adhesive to the correspondent parts,
a bi-adhesive tape, with a peel-off protective film, is put on the upper part, behind the nose clip,
the upper and lower parts are jointed through ultrasonic welding along the curved profile of the round part,
through a shaped cutter the protective equipment is cut along the perimeter that includes the two edges to place the elastic band holders,
the two elastic band holders are fixed on the two edges through an ultrasonic welding,
therefore the elastic bands are put into the elastic band holders.

56. Process as claimed in claim 53 characterized in that a few steps are included in only one.

57. Process as claimed in claim 56 characterized in that some cutting and welding operations take place contemporaneously.
